(19) United States
(12) Patent Application Publication
(10) Pub. No.: US 2015/0325103 A1
(43) Pub. Date: Nov. 12, 2015

(54) MONITORING AND TRACKING OF TROLLEYS AND OTHER TRANSPORTING UNITS

(71) Applicants: Mark Vuong Toan Ngyeun, Stanmore NSW (AU); MDT Innovations Sdn Bhd, Kuala Lumpur (AU)

(72) Inventors: Mark Vuong Toan Ngyuen, Stanmore NSW (AU); Choon Lian Liew, Kuala Lumpur (MY); Hon Wai Sim, Kuala Lumpur (MY); Wei Loong Yap, Kuala Lumpur (MY); Chee Yoong Lam, Kuala Lumpur (MY)

(21) Appl. No.: 14/387,673

(22) PCT Filed: Mar. 25, 2013
(86) PCT No.: PCT/AU2013/000293

§ 371 Date: Sep. 24, 2014

(30) Foreign Application Priority Data
Mar. 26, 2012 (MY) PI2012001356

(51) Int. Cl. G08B 25/10

(52) U.S. Cl. CPC G08B 25/10

(57) ABSTRACT

The present invention provides a system for monitoring and tracking transporting units. The system utilizes a monitoring device fitted to a transporting unit to collect data pertaining to the transporting unit and transferring the data along with a unique ID for monitoring device it to a reader device for a particular geographical area. Each reader device for a geographical area transfers data collected for a plurality of monitoring devices in its geographical area to a centralized server. The server stores the data in a database. The data server uses algorithms to calculate positions of transporting units, load managing for the reader devices, boundary crossing occurrences by a transporting unit, triggering alarm and/or locking wheels for the transporting unit when the device is out-of-range or stolen, and for searching the transporting unit. A user can view the data stored, data computed via. Algorithms and alerts are generated by the data server.

### FIELD OF INVENTION

The present invention relates to a method and system for real-time monitoring and tracking of transporting units. In particular, the invention is directed to a method and system for real-time monitoring and management of shopping trolleys and the like.

### BACKGROUND OF THE INVENTION

Certain companies, such as construction companies, coal mining companies, manufacturing companies and the like have to deal with scores of transporting units, such as vehicles, trailers, carts and trolleys on a daily basis. The complex and large-scale operations of transporting unit fleet owners requires that the owners keep track of the status and general location of their transporting units as accurately as possible. For managing and monitoring information regarding such transporting units, it has become imperative to have a centralized management system.

There are a number of prior art methods that deal with managing and monitoring transporting units. Global Positioning System (GPS) has significantly assisted these efforts, as geographic location can now be pinpointed within a span of a few meters, allowing position information of vehicles to be determined with great precision. A GPS-based tracking system coupled with a method of reporting a current location for a vehicle, can provide the kind of centralized tracking and management that fleet owners need, particularly when hundreds of vehicles must be tracked. There a number of available systems based on GPS or satellites for tracking vehicles. These systems include the “OmniTracs” system from Qualcomm, Inc., and the Orbcomm data messaging system from Orbcomm, Inc. Such systems generally have a GPS system and a satellite-based data messaging system. Messages containing information regarding the vehicle are communicated between the vehicle and a central managing entity through the satellite-based system.

Satellite based systems require a considerable amount of power to communicate with satellites orbiting thousands of kilometers above the earth. Such satellites are used in Qualcomm's OmniTracs system. These systems are dependent on a vehicle system to be powered by the vehicle engine or battery, and are not generally suited to trolleys or trailers not provided with power systems.

Cellular-based modem systems, which use cellular-based systems for communications and data messaging, require less power than traditional satellite-based systems. These systems can be used for trolleys, but are generally only effective in urban areas and do not work appropriately in areas where there is little or no network coverage.

Shopping centers, supermarkets and other retailers provide shopping trolleys (or carts) to allow customers to carry and purchase goods, and transport these goods between the store and their vehicle typically in a car-park associated with the store and/or a shopping center. One of the problems faced by such supermarkets and other retailers is the removal of such shopping trolleys from the shopping center and car-park, as some customers use the trolleys to take purchased goods home, whilst others including youths and children will remove shopping trolleys for joyrides and other purposes. In many instances shopping trolleys removed from shopping centers and their associated car parks puts a large cost impost on retailers, shopping centers and local councils, as shopping trolleys are commonly abandoned in the street, and must be searched for, collected and returned. Furthermore shopping trolleys removed from shopping centers and their associated car parks generally require greater maintenance and repair, as such trolleys are not intended for street use and they are sometimes vandalized.

Various attempts have been made to minimize the removal of shopping trolleys from a retail environment. For example, some retailers lock the shopping trolleys together, and employ a coin release mechanism, which requires a shopping trolley to be returned to a trolley bay in order to have the coin refunded.

There are also situations where a particular retailer such as a supermarket is providing the shopping trolleys for their customers, but the supermarket is part of a larger shopping center. Some local councils consider the shopping center liable for poor management of shopping trolleys, and other local councils consider both the supermarket and shopping center liable. Thus it is important for a method and system to be provided that allows for managing shopping trolleys in a retail environment that is beneficial to all.

Some of the earlier mentioned GPS-based tracking systems and the known cellular based systems are not suited to shopping trolleys due to either power consumption, size and cost issues. Another issue is that many shopping centers have underground or covered car parks and use of GPS and cellular based systems can be difficult in such retail environments.

There have been some attempts to employ transponder/scanner or RFID technology to monitor or track trolleys within supermarkets, such as that described in International Publication No. WO 1996/04161 (Tec Carte International Pty Ltd) and International Publication No. WO 2006/087070 (all4Retail SA). However, the simplistic scanner/transponder system and device disclosed in WO 1996/04161, is not suited to supermarkets within large shopping centers with vast and in many instances multi-leveled car parks above and below ground. WO 2006/087070 describes how an RFID tag and transponder in a “belt form” can be wrapped around the tubular handle of a shopping trolley and secured thereto. Both these disclosures make simplistic references to use RFID technology to identify shopping trolleys, but do not disclose an effective method or system to monitor shopping trolleys.

There are known electronic systems which utilize an electronic locking wheel fitted to each shopping trolley. A RFID high frequency transmitter with a thin wire is placed around the perimeter boundary of the parking lot of the supermarket, and the wheel locks when the trolley leaves the designated area. Store personnel must then deactivate the lock with a hand-held remote to return the trolley to stock. Often a line is painted in front of the broadcast range to warn customers that their trolley will stop when rolled past the line. However, these systems are very expensive to install and maintain and not practical in some larger retail environments with large perimeter boundaries and multiple entry points. Furthermore, such electronic systems require council approval to be operated.

Thus there is a need for low power consuming system to monitor trolleys, and in particular shopping trolleys in real time.

### SUMMARY OF THE INVENTION

In a first aspect the present invention consists in a method of tracking and monitoring a plurality of transporting units comprising:

each of said transporting units is provided with a respective monitoring device mounted thereto, each of said monitoring devices having a unique ID associated therewith, each of said monitoring devices capable of sending data along with said unique ID using wireless communication;
a plurality of spaced apart reader devices are each capable of receiving data sent by said monitoring devices;
sending said data acquired by said reader devices to a data server, along with a unique address associated with each reader device; and
receiving said data sent by said data server and storing same in a database: and wherein said monitoring devices are communicating with the reader devices via a local area network, and the reader devices and the data server are communicating via a TCP/IP connection, and said data server using a returned signal strength interface (RSSI) for identifying the position of said transporting units.

Preferably said data server contains at least one algorithm to calculate positioning of said transporting units, creating a priority list, a load reduction of reader devices, number of boundary line crossing occurrences, and triggering an alarm when a transporting unit goes out of range, and for searching said transporting units.

Preferably each said monitoring device acquires at least a portion of said data regarding its respective transporting unit via at least one sensor operably connected thereto.

Preferably said at least one sensor is any one or more of a motion detector, speedometer, or temperature detector.

Preferably said monitoring device comprises an alarm, such that said alarm is activated when it is determined that said transporting unit is detected out of range.

Preferably said data server sends commands to said monitoring units via their respective reader devices to control at least one on-board device on said transporting unit.

Preferably said transporting unit has wheels, and said at least one on-board device is a wheel lock, and said monitoring device has functionality to output signal to lock at least one wheel when said transporting unit is out of range, said monitoring unit locking said wheel after receiving command from said reader device.

Preferably each monitoring device comprises a battery with level indicator feeding back to at least one of said reader devices.

Preferably said monitoring devices and said reader devices comprise an AES 128 bit data cryptography functionality for secure communication.

Preferably said monitoring of said transporting units is done at a predetermined interval of time.

Preferably said monitoring devices send condition data to said reader devices at a predetermined interval of time.

Preferably said reader device comprises an on-board processor for radio transmission operation and returned signal strength filtration of monitoring devices.

Preferably said reader devices comprise wireless repeater functionality and power over Ethernet (PoE) functionality.

Preferably an external user can access said data server to monitor the information regarding said transporting units.

Preferably said external user can monitor the position of said transporting units in real-time via the monitoring devices mounted on respective transporting units.

Preferably the communication between monitoring units and reading units is based on IEEE 802.15.4.

Preferably said transporting units are shopping trolleys.

In a second aspect the present invention consists in a method of tracking and monitoring a plurality of shopping trolleys in a retail environment, said method comprising:

providing each shopping trolley with a monitoring device mounted thereto, each said monitoring device having a unique ID associated therewith, and each of said monitoring devices capable of sending data along with said unique ID using wireless communication, and for receiving signal commands;
having a plurality of spaced apart reader devices disposed at various locations within said retail environment, each reader device capable of receiving data sent by said monitoring devices, and sending signal commands to said monitoring devices;
sending said data acquired by said reader devices to a data server, along with a unique address associated with each reader device;
receiving said data sent by said data server and storing same in a database: and wherein said monitoring devices are communicating with the reader devices via a local area network, and the reader devices and the data server are communicating via a TCP/IP connection, and said data server using a returned signal strength interface (RSSI) for identifying the position of said transporting units.

Preferably said data server contains at least one algorithm to calculate positioning of the shopping trolleys, creating a priority list, a load reduction of reader devices, number of boundary line crossing occurrences; and triggering an alarm when a shopping trolley goes out of range, and for searching said shopping trolleys.

Preferably said monitoring device comprises an alarm, such that said alarm is activated when it is determined that said shopping trolley is detected out of range.

Preferably said data server sends commands to the monitoring units via their respective reader devices to control at least one on-board device on said shopping trolley.

Preferably said shopping trolley has wheels, and said at least one on-board device is a wheel lock fitted to at least one of said wheels, and said monitoring device has functionality to output a signal to lock said wheel when said shopping trolley is out of range, said monitoring unit locking said wheel after receiving command from said reader device.

Preferably each monitoring device comprises a battery with level indicator feeding back to at least one of said reader devices.

Preferably at least one reader device is portable.

In a third aspect the present invention consists in a system for monitoring and tracking of a plurality of transporting units comprising:

a monitoring device mounted on each of said transporting units, each monitoring device being operably connected to at least one transporting unit condition-sensor for sensing a condition of said transporting unit; and
each said monitoring device operably connected to a communicator for sending data acquired from said condition sensor;
a plurality of spaced apart readers devices for receiving said data sent from said monitoring devices, and acquiring the information of returned signal strength for each monitoring device; said reading devices wirelessly communicating with said monitoring devices via a personal area network; and sending said data received by said reader devices; and a data server for receiving said data sent by said reader devices, said data server communicating with said reader devices via a TCP/IP connection; said data server comprising a first functional unit to implement an algorithm for identifying transporting-unit positioning using returned signal strength interface (RSSI).

Preferably said system further comprising a second functional unit to implement an algorithm for meshing RSSI parameters of all monitoring units to create a priority list of nearest reading units.

Preferably said system further comprising a third functional unit to implement an algorithm for load reduction of the reader devices;

Preferably said system further comprising a fourth functional unit to implement an algorithm for computing boundary line crossing occurrence.

Preferably said system further comprising a fifth functional unit to implement an algorithm for triggering alarm or locking said transporting units when said transporting units go out of range.

Preferably said system further comprising a sixth functional unit to implement algorithm for searching for said transporting units;

Preferably said system further comprising a storage unit for storing addresses of active reader devices' list.

Preferably said at least one sensor is any or more of a motion detector, speedometer, or temperature detector.

Preferably each of said monitoring devices comprises an alarm, such that the alarm is activated when it is determined that said monitoring device is detected out of range.

Preferably said monitoring devices comprise a paging system for search and retrieval of said transporting units.

The present invention provides a method and system for monitoring and tracking transporting units. The system utilizes a monitoring device on the transporting unit to collect data pertaining to the transporting unit and transferring the data along with a unique ID (for monitoring device) to a reader device for the geographical area. Each reader device for a geographical area transfers data collected for a plurality of monitoring devices in its geographical area to a centralized server. The data server stores the data in a database. The data server uses algorithms to calculate positions of transporting units, load managing for the reader devices, boundary crossing occurrences by a transporting unit, triggering alarm and/or locking wheels for transporting unit when the monitoring device is out-of-range or stolen, and for searching the transporting unit. A user can view the data stored, data computed via. Algorithms and alerts are generated by the data server. The system facilities instigating the alarm, when the transporting unit goes out of range or is stolen.

The system helps in computing the current Trolley Count, Hot Zones (where trolleys mostly go). In addition the system may help Boundary detection in location base detection of trolleys.

The invention is that it shortens trolley retrieval process. The invention assists in tracking and tracing trolley movement, aging, and distance operated in real-time.

### BRIEF DESCRIPTION OF THE DRAWINGS

Other objects, features, and advantages of the invention will be apparent from the following description when read with reference to the accompanying drawings. In the drawings, wherein like reference numerals denote corresponding parts throughout the several views:

FIG. 1 illustrates a block diagram of a monitoring device for use in a system in accordance with a first embodiment of the present invention.

FIG. 2 illustrates an elevation schematic view of transporting unit made up of a vehicle and trolley fitted with a monitoring device shown FIG. 1.

FIG. 3 illustrates a block diagram of a reader device for use with the monitoring device as shown in FIG. 1.

FIG. 4 illustrates a schematic of a system which uses the monitoring and reader devices shown in FIGS. 1 and 2.

FIG. 5 illustrates a block diagram of software architecture found on a data server shown in the system of FIG. 4.

FIG. 6 illustrates a block diagram depicting communication between the monitoring device, reader device and software architecture shown in FIGS. 1, 3 and 5, respectively.

FIG. 7 illustrates a perspective view of a shopping trolley fitted with an UEMD of FIG. 1.

FIG. 8 illustrates a schematic of a system which uses the monitoring and reader devices shown in FIGS. 1 and 2, respectively with the shopping trolley shown in FIG. 7.

### DETAILED DESCRIPTION OF THE PREFERRED EMBODIMENTS

The invention is related to a method for centralized management and monitoring of transporting units.

The term “transporting unit” may be used for any mobile unit used for transporting goods and/or people, and includes within its meaning vehicles, trailers, carts and trolleys, including shopping trolleys. It can also mean a vehicle in combination with a trolley or cart.

A monitoring device is preferably mounted to a transporting unit and will collect required parameters about the transporting unit. The monitoring device will hereafter be referred as “UEMD” which stands for Ubiquitous Electronic Monitoring Device. The ubiquitous monitoring devices would be read by a reading device. The reading device would hereafter be referred as “UEMR”, which stands for Ubiquitous Electronic Monitoring Readers.

The data read will be forwarded to a server which will compute store and use the data for further computations and alerts. The software in server will hereafter be referred as “UEMS”, which stands for Ubiquitous Electronic Monitoring Software.

The terms to be used will be merely representative terms for the devices or components used which might be available in various forms in the market. Anyone skilled in the art may construe that the devices mentioned can be replaced with different form of devices suiting the requirement in the scope of the invention.

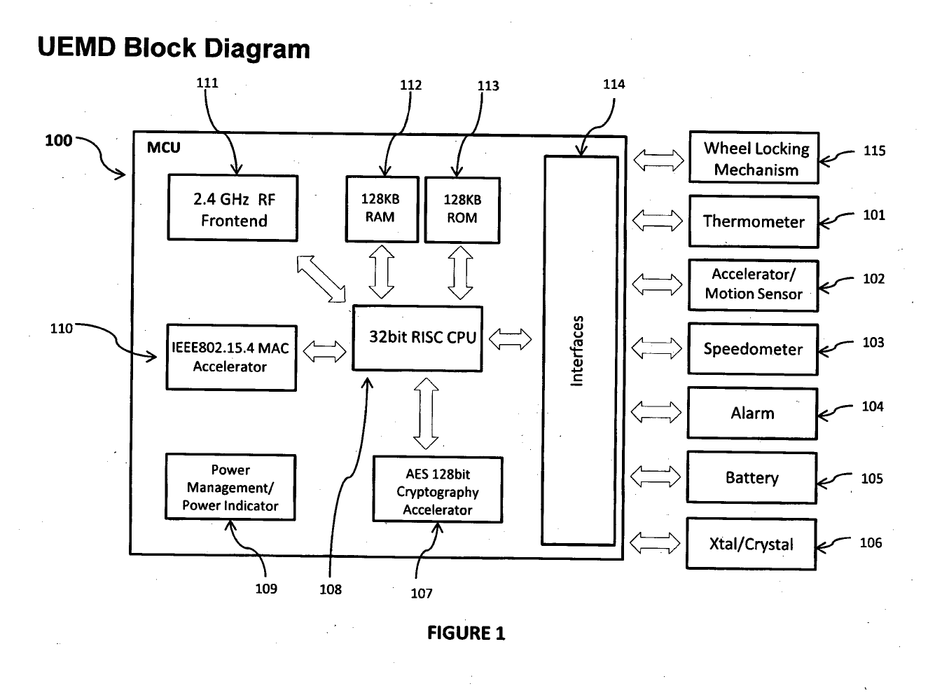

FIGS. 1 to 6 depict a first embodiment of a method of tracking and monitoring a plurality of transporting units in accordance with the present invention.

FIG. 1 depicts the internal structure of the UEMD (monitoring device) 100 comprising a “microcontroller unit” having a RISC (Reduced Instruction Set Computing) CPU 108. The microcontroller unit of UEMD 100 also comprises a RAM 112, a ROM 113, a 2.4 GHz RF frontend 111, an IEEE 802.15.4 MAC accelerator 110, and a power indicator 109. UEMD 100 is provided with a 128 bit advanced encryption standard (AES) accelerator 107. An interface 114 helps it gather data from sensors and other external sources mounted on transporting unit 401. UEMD 100 has or is linked to an on-board motion detector (g-sensor) 102 to determine if transporting unit 401 is stationary or how it is moving, an on-board speedometer 103 log to determine the distance a transporting unit has travelled, an on-board thermometer 101 for determining the ambient temperature, an on-board alarm 104 to detect theft or removal when out of range, an on-board alarm as a paging system for transporting unit 401, and search and retrieval and an on-board battery 105 with level indicator feeding back to a UEMR (reader device) 405. Crystal oscillator 106 is for the timing requirements of CPU 108. The on-board radio transmitter is used for transmitting and receiving a unique ID, receiving signal strength and also other pre-programmed data. UEMD 100 also has on-board I/O mechanism to optionally output signal to a wheel loch mechanism 115 to lock wheels when the vehicle is out of range or stolen.

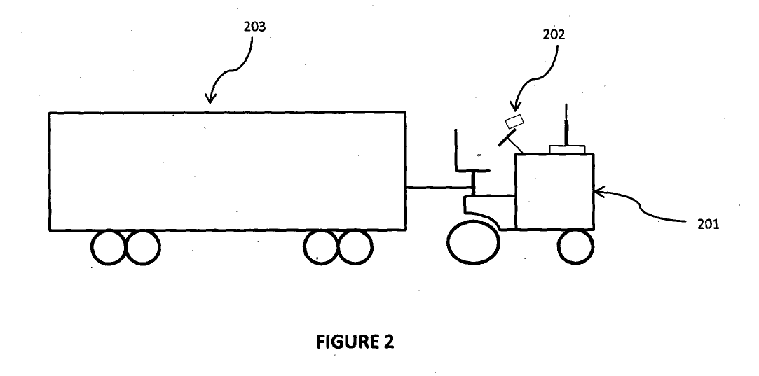

FIG. 2 represents an embodiment of transporting unit 401 made up of a powered vehicle and a towed trolley 203 in combination. The present system will help in monitoring and managing such a transporting unit 401. The UEMD device 100 mentioned in FIG. 1 can be mounted on any suitable position on vehicle 201 or trolley 203. In the present embodiment UEMD 100 is installed to the steering wheel of vehicle 201.

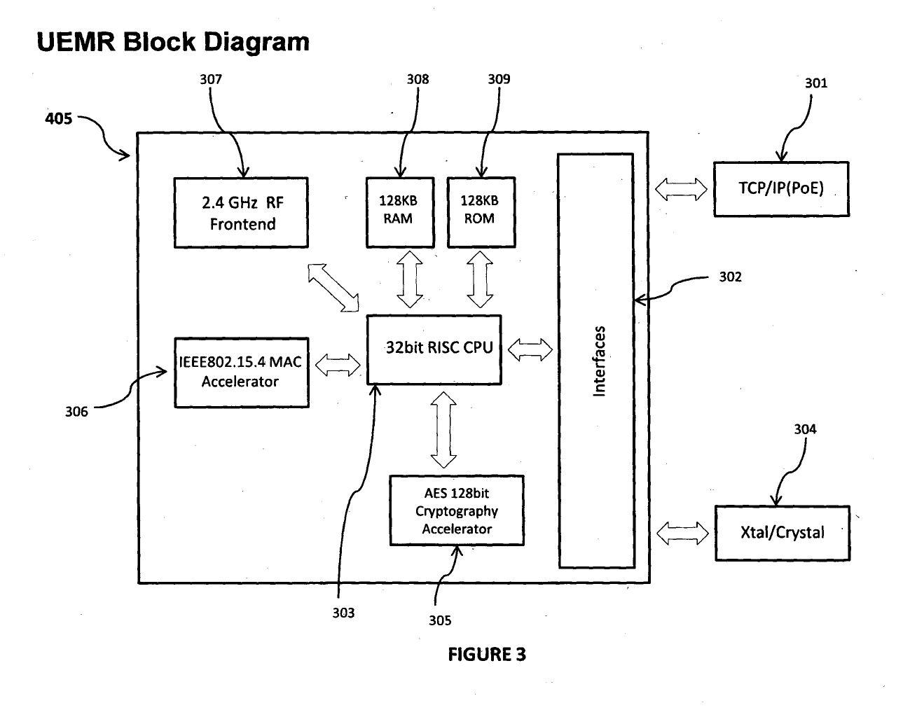

FIG. 3 illustrates a block diagram of UEMR 405, which comprises a microcontroller unit having a RISC (Reduced Instruction Set Computing) CPU 303. UEMR 405 also comprises a RAM 308, a ROM 309, a 2.4 GHz RF frontend 307, and IEEE 802.15.4 MAC accelerator 306. UEMR 405 is provided with a 128 bit advanced encryption standard (AES) accelerator 107 Crystal oscillator 304 is for the timing requirements of CPU 303. UMER device has a TCP/IP interface with an external central monitoring server. The on-board processor handles radio transmission operation, and UEMDs' 100 returned signal strength filtration. Also there may be an on-board wireless repeater function.

Power over Ethernet (PoE) function is provided with UEMR 405, which enables same to pass electrical power safely, along with data, on Ethernet cabling. The IEEE standard for PoE requires Category 5 cable or higher for high power levels, but can operate with category 3 cable for low power levels.

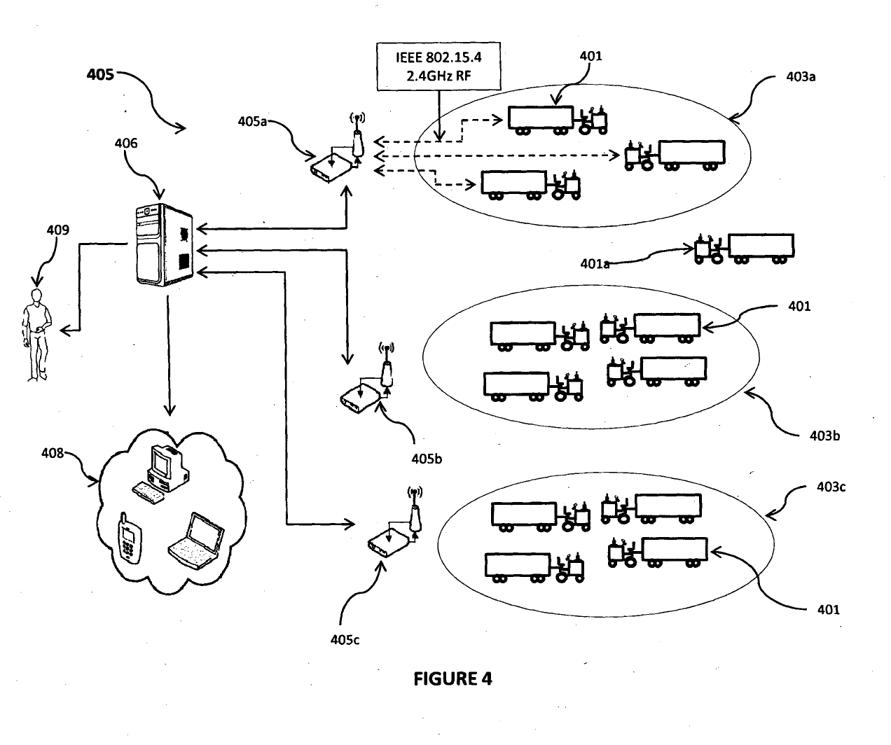

FIG. 4 illustrates an overall centralized transporting unit monitoring and management system in the form of a wireless network. This system will hereafter be referred as UMOT 400 which stands for “Ubiquitous Monitoring of Transporting Units”. A number of UEMRs (with antennas) 405a-c are provided. Each of these UEMRs 405 cover transporting units 401 each mounted with an UEMD 100, in a particular geographical area 403a, 403b and 403c.

The UEMDs 100 each collect a plurality of information pertaining to respective (associated) transporting units 401. Each UEMD 100 has its own unique ID which it sends along with the data it has collected. Each UEMR 405a, 405b and 405c reads data from UEMDs 100 and sends control commands to a plurality of UEMDs 100 mounted on respective transporting units 401. For example UMER 405a reads data from and send control commands to UMEDs 100 mounted on transporting units 401 in region 403a. Similarly UEMRs 405b and 405c read and send control commands to the UEMDs 100 of transporting units 401 in regions 403b and 403c, respectively. The communication between UEMDs 100 and UEMRs 405 is based on wireless local (or personal) area network (WLAN). In the present embodiment, IEEE 802.15.4 for example can be used. IEEE 802.15.4 is a standard which specifies the physical layer and media access control for low-rate wireless local area networks. The mode of communication between UEMDs and UEMRs shall not be restricted with IEEE 802.15.4 only. Standards such as ZigBee, ISA100.11a, WirelessHART, and MiWi specification (each of which further extends the standard by developing the upper layers which are not defined by 802.15.4) may be used for this purpose. The position of UMERs 405 in this embodiment is shown outside the virtual geographical area, but it shall be appreciated that UMERs 405 may occupy any suitable position to cover the UMEDs 100. The communication between UEMDs 100 and UEMRs 405 is encrypted, so as to ward-off any possibility of an intruder or a hacker gaining access to the information under communication. The communication uses AES 128 bit encryption for both UEMDs 100 and UEMRs 405. Each UEMR 405 measures the returned signal strength (RSS) of the UEMDs 100. Once the data of UEMDs 100 has been obtained by respective UEMRs 405, it sends the data to data server 406 via a TCP/IP link. Each UEMR 405 also sends its address to data server 406 along with the data sent by each UEMD 100. Also, importantly each UEMR 405 forwards the information regarding the RSS of each UEMD 100 to data server 406. The UEMS software in data server 406 implements a number of algorithms to calculate for e.g. trolley positioning, create priority list of nearest UEMRs 405, load balancing of UEMRs 405, boundary line crossing occurrences of UEMDs 100, to lock a transporting unit 401a when it goes out of range, and searching for transporting units 401. When a transporting unit 401a goes out of range, data server 406 sends a TDD (Trolley Theft Deterrent) command to the UEMD 100 associated therewith, to initiate the on-board alarm. In another case, when transporting unit 401a is determined to be stolen, data server 406 may send a command to lock transporting unit 401a via UEMR 405a to UEMD 100; the UEMD 100 in turn initiates a signal to lock one or more of the wheels of transporting unit 401a. In this way transporting unit 401a can be prevented from being stolen.

In another embodiment of the invention either or both of TDD command and lock command may be sent by the UEMR 405a itself (without involving data server 406) after determining that the returned signal strength (RSS) has fallen below a particular threshold.

Server 406 may provide an access to it via a user interface to a user 409 directly or via a host of fixed terminals or portable devices 408.

UMOT 400 helps in computing the current transporting unit count and “hot zones” (where trolleys mostly go). In addition UMOT 400 system may help boundary detection in “location based” detection of transporting units 401.

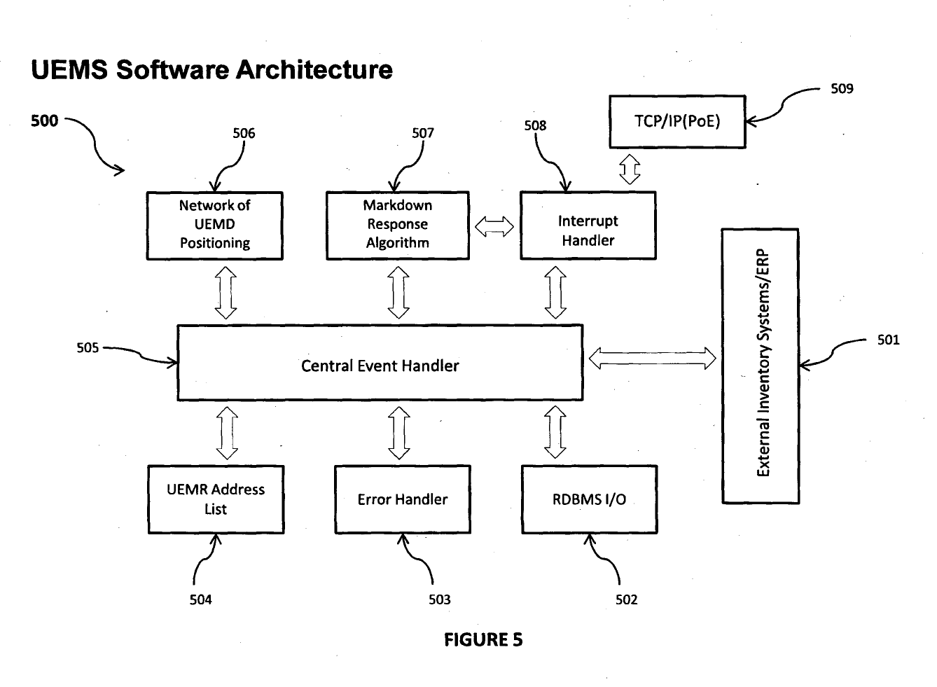

FIG. 5 represents the software architecture 500 in data server 406 hereafter referred as UEMS which stands for “Ubiquitous Electronic Monitoring Software”. UEMS 500 is designed using event driven architecture, which is important because of the state of UEMDs 100 change every single second. UEMS 500 primarily uses Central Event Handler 505 to create program threads dynamically to handle changes in UEMDs 100 and other sensors concurrently. In UEMS 500, Interrupt Handler 508 is used to intercept core procedures and functions to allow Central Event Handler 505 create dynamic threats. The UEMS 500 can have a functional unit to determine NTP (Network of Trolley Positioning) using RSSI (return signal strength interface).

The Mark Down Response Algorithm (MRA) 507 is an ongoing procedure that computes the following to avoid heavy load at Central Event Handler 505:

A.) Meshes all UEMDs' 100 RSSI parameters to create priority list of nearest UEMRs 405
b.) Filters distanced UEMDs 100 away from UEMR 405 for load reduction.
C.) Computation boundary line crossing occurrences.
D.) ORA (Out of Range Alert) to trigger alarm and lock the wheels when transporting unit is stolen/taken out from compound
E.) Determining algorithm to search transporting units using portable computing device and page transporting units 401 as a form of acknowledgment from transporting units 401 that are detected within a 65° radius in front.

The UEMS 500 maintains the UEMR Address List to manage all online UEMR 405. UEMR Address List 504 and Network of UEMD Positioning 506 are used to plot the positioning of transporting units within a floor map.

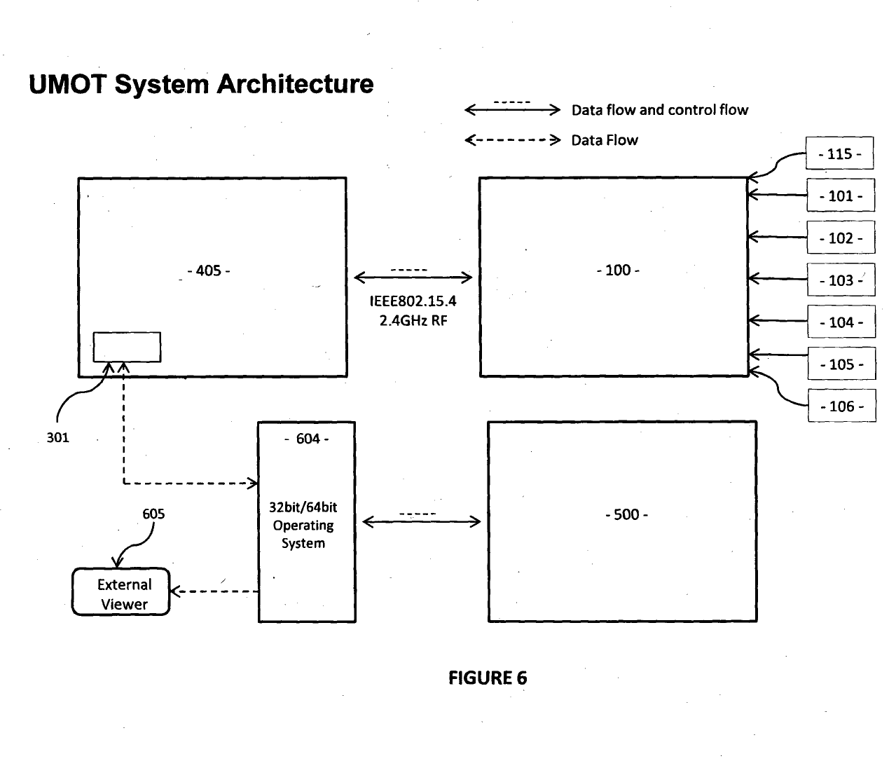

FIG. 6 illustrates the UMOT 400 system architecture in a block diagram. UEMD 100 is communicating with a UEMR 405 via a IEEE 802.15.4 2 GHz, RF link. UEMD 100 is collecting and sending the information regarding a transporting unit 401. The data is sent to UEMS 500 in server 406. The UEMS 500 server 406 may have a 32 Bit or 64 bit operating system 604 based on windows/Linux. An external viewer 605 can view the computed information regarding the UEMDs 100 via a user interface.

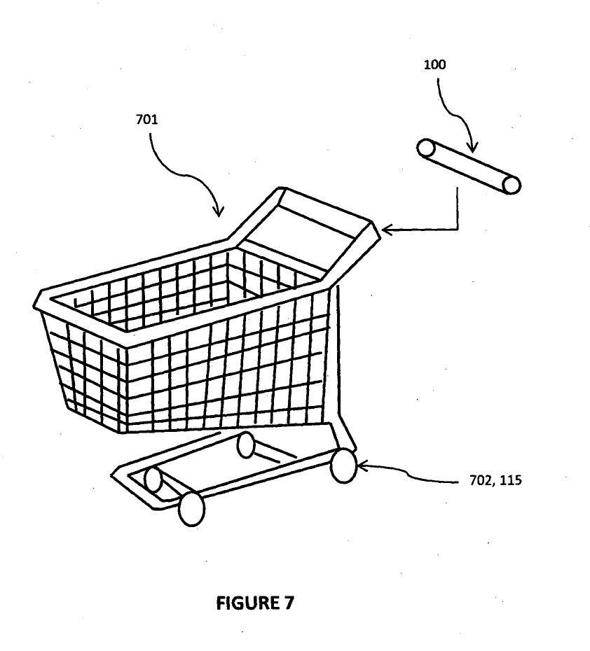

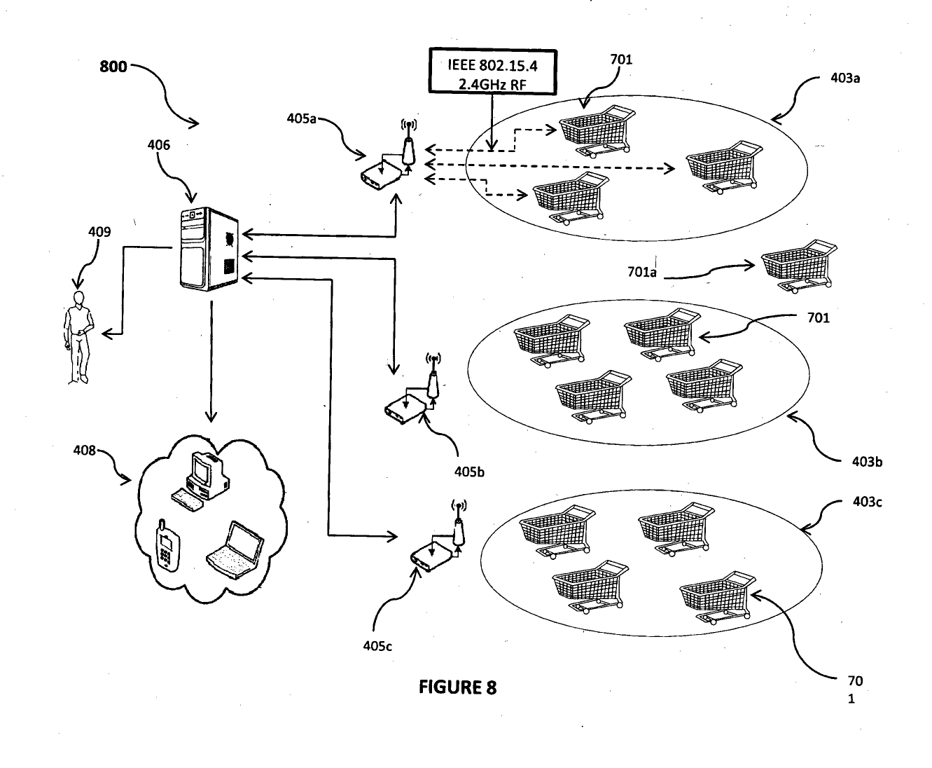

FIGS. 7 and 8 depict a second embodiment of a method of tracking and monitoring a plurality of shopping trolleys. FIG. 7 depicts a shopping trolley 701 of the type used in supermarkets, shopping malls and other retail environments. A UEMD 100 as shown in FIG. 1 of the first embodiment is mounted to trolley 701. In the present embodiment UEMD 100 is preferably hidden from view and may be installed internally of the handle of shopping trolley 701.

FIG. 8 depicts an overall centralized trolley monitoring and management system in the form of a wireless network. This system will hereafter be referred as UMOT 800. It is similar to the UMOT 400 system shown with reference to FIG. 4, however in this present system it is a plurality of trolleys 701, rather than transporting units 401 that are being monitored and managed.

The UEMD 100 fitted to shopping trolley 701, may be operably connected to various sensors on a trolley 701 via interface 114. The sensors on the trolley may be motion detector 102, speedometer 103, and thermometer 101. Other on board devices fitted to the may be an alarm 104 and battery 105 with level indicator. Shopping trolley 701 may also be fitted with at least one locking wheel 702 with an internal locking mechanism 115. Interface 114 as in the first embodiment gathers data from sensors and other external sources mounted on trolley 701.

UEMD 100 is able to determine if trolley 701 is stationary or moving, its speedometer 103 logs the distance trolley 701 has travelled, thermometer 101 determines the ambient temperature, and Accelerator logs 102 the harshness that trolley 701 has been subjected to. Alarm 104 may produce an audible alarm sounded if say a trolley 701a is out of range by removal from the designated retail environment.

UEMD 100 like that of the first embodiment has a radio transmitter used for transmitting and receiving a unique ID, receiving signal strength and also other pre-programmed data. UEMD 100 also has on-board I/O mechanism to optionally output signal to actuate wheel locking mechanism 115 disposed within wheel 702, when trolley 701a is out of range by removal from the designated retail environment. The locking of wheel 702 by wheel locking mechanism may be for a predetermined time period of say about 10-15 minutes at which time the wheel lock will then automatically release. Alternatively the wheel lock mechanism 115 may unlock, once trolley 701a is brought back into range or when personnel de-activate the lock mechanism using a hand-held remote.

As shown in FIG. 8, the UMOT 800 system uses a plurality of UMERs 405 in wireless communication with a data server 406 in a WLAN. As in the first embodiment, each of these UMER 405 cover shopping trolleys each mounted with an UEMD 100, in a particular geographical area 403a, 403b and 403c. Whilst FIG. 8, shows distinct particular geographical areas associated with trolleys 701 for ease of reference, it should be understood that the particular areas covered by UMERs 405 will overlap. This means that whilst a trolley 701 and its respective UEMD 100 may be close to one particular UMER 405, it can still communicate with one or more other UMERs 405 in the designated retail environment. UEMDs 100 each collect a plurality of information pertaining to respective (associated) trolleys 701. Each UEMD 100 has its own unique ID which it sends along with the data it has collected. Each UEMR 405a, 405b and 405c reads data from UEMDs 100 and sends control commands to a plurality of UEMDs 100 mounted on respective trolleys 701.

In this UMOT 800 system the UEMRs 405 use returned signal strength (RSS) from the UEMDs 100. Because a plurality of UEMRs 405, are capable of receiving a signal from a particular UEMD 100 and its associated trolley 701, its position can be identified by intersection and/or triangulation.

An advantage of the present embodiment is that very low power sources (small inexpensive batteries) can be used in UMEDs 100 fitted to trolleys 701. A further advantage is that because a WLAN can be used to wirelessly connect data server 406 and UEMRs 405, it can readily be installed in a retail environment such as in a supermarket and/or shopping centre and its associated car parks.

In order to assist in retrieval of trolleys one or more UEMR 405 readers may be in a portable form, either fitted to a vehicle used for trolley retrieval or in a hand-held portable device, which can also unlock wheel lock mechanism 115. Such portable forms of the UEMR 405 may assist trolley retrieval personnel in locating trolleys in large retail environments and when trolleys are removed out of range.

The advantage of the present invention is that it shortens trolley retrieval process. The invention assists tracking and monitoring trolley movement, aging, and distance operated in real-time. The system also provides analytical data hot zones, where trolleys 701 congregate the most, and the boundaries of the retail environment at which most trolleys are removed.

Furthermore the various sensors can in a real time provide alerts to trolleys being stolen or used harshly or intentionally damaged.

Also the database in data server 406 can be used to keep a log of movements of trolleys 701. The data can be stored and used empirically for analysis of trolley movements within say a supermarket or other retail store, and the larger retail environment, which includes other shopping center/mall movements. This information may be commercially beneficial to those operating and managing supermarkets and shopping centers, and those planning and building future supermarkets and shopping centers.

The first embodiment is directed to a transporting unit made up of a powered vehicle 201 and towed trolley 203 as shown in FIG. 2, whilst the second embodiment is directed to a shopping trolley 701 as shown in FIG. 7. However it should be understood that the present invention is suitable for all sorts of transporting units, including those operating in geographic areas of a larger size than a retail environment, including but not limited to golf-buggies, factory and warehouse buggies and/or trolleys, and airport baggage transporting units.

As will be readily apparent to those skilled in the art, the present invention may easily be produced in other specific forms without departing from its essential characteristics. The present embodiments is, therefore, to be considered as merely illustrative and not restrictive, the scope of the invention being indicated by the claims rather than the foregoing description, and all changes which come within therefore intended to be embraced therein.

Although the present invention has been described in connection with the preferred form of practicing it, those of ordinary skill in the art will understand that many modifications can be made thereto within the scope of the claims that follow. Accordingly, it is not intended that the scope of the invention in any way be limited by the above description, but instead be determined entirely by reference to the claims that follow.

1. A method of tracking and monitoring a plurality of transporting units comprising:
(i) each of said transporting units is provided with a respective monitoring device mounted thereto, each of said monitoring devices having a unique ID associated therewith, each of said monitoring devices capable of sending data along with said unique ID using wireless communication;
(ii) a plurality of spaced apart reader devices are each capable of receiving data sent by said monitoring devices;
(iii) sending said data acquired by said reader devices to a data server, along with a unique address associated with each reader device; and
(iv) receiving said data sent by said data server and storing same in a database: and
wherein said monitoring devices are communicating with the reader devices via a local area network, and the reader devices and the data server are communicating via a TCP/IP connection, and said data server using a returned signal strength interface (RSSI) for identifying the position of said transporting units.

2. The method of claim 1 wherein said data server contains at least one algorithm to calculate positioning of said transporting units, creating a priority list, a load reduction of reader devices, number of boundary line crossing occurrences, and triggering an alarm when a transporting unit goes out of range, and for searching said transporting units.

3. The method of claim 1 wherein each said monitoring device acquires at least a portion of said data regarding its respective transporting unit via at least one sensor operably connected thereto.

4. The method of claim 3 wherein said at least one sensor is any one or more of a motion detector, speedometer or temperature detector.

5. The method of claim 1 wherein said monitoring device comprises an alarm, such that said alarm is activated when it is determined that said transporting unit is detected out of range.

6. The method of claim 1, wherein said data server sends commands to said monitoring units via their respective reader devices to control at least one on-board device on said transporting unit.

7. The method of claim 6, wherein said transporting unit has wheels, and said at least one on-board device is a wheel lock, and said monitoring device has functionality to output signal to lock at least one wheel when said transporting unit is out of range, said monitoring unit locking said wheel after receiving command from said reader device.

8. The method of claim 1 wherein each monitoring device comprises a battery with level indicator feeding back to at least one of said reader devices.

9. The method of claim 1 wherein said monitoring devices and said reader devices comprise an AES 128 bit data cryptography functionality for secure communication.

10. The method of claim 1 wherein said monitoring of said transporting units is done at a predetermined interval of time.

11. The method of claim 1 wherein said monitoring devices send condition data to said reader devices at a predetermined interval of time.

12. The method of claim 1 wherein said reader device comprises an on-board processor for radio transmission operation and returned signal strength filtration of monitoring devices.

13. The method of claim 1 wherein said reader devices comprise wireless repeater functionality and power over Ethernet (PoE) functionality.

14. The method of claim 1 wherein an external user can access said data server to monitor the information regarding said transporting units.

15. The method of claim 14 wherein said external user can monitor the position of said transporting units in real-time via the monitoring devices mounted on respective transporting units.

16. The method of claim 1, wherein the communication between monitoring units and reading units is based on IEEE 802.15.4.

17. The method of claim 1, wherein said transporting unit is a shopping trolley.

18. A method of tracking and monitoring a plurality of shopping trolleys in a retail environment, said method comprising:
providing each shopping trolley with a monitoring device mounted thereto, each said monitoring device having a unique ID associated therewith, and each of said monitoring devices capable of sending data along with said unique ID using wireless communication, and for receiving signal commands;
having a plurality of spaced apart reader devices disposed at various locations within said retail environment, each reader device capable of receiving data sent by said monitoring devices, and sending signal commands to said monitoring devices;
sending said data acquired by said reader devices to a data server, along with a unique address associated with each reader device;
receiving said data sent by said data server and storing same in a database: and
wherein said monitoring devices are communicating with the reader devices via a local area network, and the reader devices and the data server are communicating via a TCP/IP connection, and said data server using a returned signal strength interface (RSSI) for identifying the position of said transporting units.

19. The method of claim 18, wherein said data server contains at least one algorithm to calculate positioning of the shopping trolleys, creating a priority list, a load reduction of reader devices, number of boundary line crossing occurrences, and triggering an alarm when a shopping trolley goes out of range, and for searching said shopping trolleys.

20. The method of claim 18 wherein said monitoring device comprises an alarm, such that said alarm is activated when it is determined that said shopping trolley is detected out of range.

21. The method of claim 18, wherein said data server sends commands to the monitoring units via their respective reader devices to control at least one on-board device on said shopping trolley.

22. The method of claim 21, wherein said shopping trolley has wheels, and said at least one on-board device is a wheel lock fitted to at least one of said wheels, and said monitoring device has functionality to output a signal to lock said wheel when said shopping trolley is out of range, said monitoring unit locking said wheel after receiving command from said reader device.

23. The method of claim 18 wherein each monitoring device comprises a battery with level indicator feeding back to at least one of said reader devices.

24. The method of claim 18, wherein at least on reader device is portable.

25. A system for monitoring and tracking of a plurality of transporting units comprising:
a monitoring device mounted on each of said transporting units, each monitoring device being operably connected to at least one transporting unit condition-sensor for sensing a condition of said transporting unit; and
each said monitoring device operably connected to a communicator for sending data acquired from said condition sensor;
a plurality of spaced apart readers devices for receiving said data sent from said monitoring devices, and acquiring the information of returned signal strength for each monitoring device; said reading devices wirelessly communicating with said monitoring devices via a personal area network; and sending said data received by said reader devices;
and a data server for receiving said data sent by said reader devices, said data server communicating with said reader devices via, a TCP/IP connection; said data server comprising a first functional unit to implement an algorithm for identifying transporting-unit positioning using returned signal strength interface (RSSI).

26. The system of claim 25 further comprising a second functional unit to implement an algorithm for meshing RSSI parameters of all monitoring units to create a priority list of nearest reading units.

27. The system of claim 26 further comprising a third functional unit to implement an algorithm for load reduction of the reader devices;

28. The system of claim 27 further comprising a fourth functional unit to implement an algorithm for computing boundary line crossing occurrence.

29. The system of claim 28 further comprising a fifth functional unit to implement an algorithm for triggering alarm or locking said transporting units when said transporting units go out of range.

30. The system of claim 28 further comprising a sixth functional unit to implement algorithm for searching for said transporting units;

31. The system of claim 29, further comprising a storage unit for storing addresses of active reader devices' list.

32. The system of claim 25 wherein said at least one sensor is any or more of a motion detector, speedometer or temperature defector.

33. The system of claim 25 wherein each of said monitoring devices comprises an alarm, such that the alarm is activated when it is determined that said monitoring device is detected out of range.

34. The system of claim 25 wherein said monitoring devices comprise a paging system for search and retrieval of said transporting units.
